(19) United States
(12) Patent Application Publication
(10) Pub. No.: US 2019/0100120 A1
(43) Pub. Date: Apr. 4, 2019

(54) VEHICLE SEAT

(71) Applicant: TOYOTA BOSHOKU KABUSHIKI KAISHA, Aichi (JP)

(72) Inventor: Taku IMAJO, Aichi (JP)

(73) Assignee: TOYOTA BOSHOKU KABUSHIKI KAISHA, Aichi (JP)

(21) Appl. No.: 16/148,412

(22) Filed: Oct. 1, 2018

(30) Foreign Application Priority Data
Oct. 4, 2017 (JP) 2017-194568

(51) Int. Cl. B60N 2/08; B60N 2/68; B60N 2/07

(52) U.S. Cl. CPC B60N 2/08; B60N 2/0732; B60N 2/68

(57) ABSTRACT

Provided is a vehicle seat where a total cost thereof can be reduced through commonization of parts. The vehicle seat includes: a movable rail that is attached to a cushion frame with a spacer therebetween; a fixed rail that has a bottom wall facing the movable rail; a locking mechanism that locks the fixed rail to a floor; a first bracket that is attached to a cushion frame; and a second bracket that is attached to the bottom wall of the fixed rail and the locking mechanism in a connecting manner. The first bracket includes a concave portion. The second bracket includes a convex portion that engages with the concave portion. The concave portion overlaps the fixed rail if viewed in a direction orthogonal to the bottom wall as well as the spacer if viewed in a direction parallel to the bottom wall and orthogonal to a sliding direction.

### CROSS-REFERENCE TO RELATED APPLICATIONS

The present application claims the benefit of Japanese Patent Application No. 2017-194568 filed on Oct. 4, 2017 with the Japan Patent Office, the entire disclosure of which is incorporated herein by reference.

### BACKGROUND

The present disclosure relates to a vehicle seat.

For example, in a vehicle seat attached to an automobile and the like, a cushion frame supporting a seat cushion is equipped with a sliding mechanism to allow the seat cushion to slide in a front-rear direction. Such a sliding mechanism comprises: a fixed rail that is fixed to a floor of a vehicle; and a movable rail that is slidable in relation to the fixed rail.

In addition to the above-indicated sliding mechanism, some vehicle seats comprise a tumble mechanism that allows a rear side of the seat cushion with a seat back folded to be movable upward in relation to the floor. The tumble mechanism is realized by a locking mechanism that enables switching between a locked state where the fixed rail is locked in relation to the floor and an unlocked state where the fixing of the fixed rail to the floor is released (see Japanese Unexamined Patent Application Publication No. H09-71166).

An engagement member is disposed between the cushion frame and the locking mechanism so as to transmit power therebetween. Such an engagement member comprises: a first bracket attached to the cushion frame; and a second bracket attached to the locking mechanism and the fixed rail.

### SUMMARY

As the sliding mechanism of the vehicle seat, there are: a manual type where the movable rail is manually slidable; and an automatic type where the movable rail is automatically slidable by an actuator or the like. Between the manual type and the automatic type, outer shapes of the movable rail and the fixed rail are different since types and shapes of parts disposed inside the rails are different. Specifically, heights of the movable rail and the fixed rail of the manual type are smaller than those of the movable rail and the fixed rail of the automatic type.

Further, depending on a design of a vehicle, a space between the fixed rail and the floor in an up-down direction is small and the locking mechanism cannot be disposed below the fixed rail in some cases. In such a case, the locking mechanism is disposed on a side of the fixed rail and the movable rail, and the second bracket extends from a bottom wall of the fixed rail to the side of the fixed rail and the movable rail so as to engage with the first bracket.

When the locking mechanism is disposed on the side of the rails, since a position of the bottom wall of the fixed rail differs between the manual type and the automatic type as described above, it is necessary to change a shape of the second bracket attached to the fixed rail between the manual type and the automatic type. As a result, even for a single model of the vehicle (that is, an identical model of the vehicle), it is necessary to prepare different types of parts, resulting in an increase in a total product cost.

Alternatively, it is conceivable to change the shapes of the movable rail and the fixed rail of the manual type sliding mechanism so that the heights thereof become the same as those of the rails of the automatic type sliding mechanism. However, such a change in the shapes of the movable rail and the fixed rail may cause optimality of the shapes to be lost, thereby increasing the cost adversely.

It is preferable that one aspect of the present disclosure provides a vehicle seat whose total cost can be reduced through commonization of parts of a sliding mechanism.

One embodiment of the present disclosure is a vehicle seat comprising: a cushion frame; a movable rail; a fixed rail; a locking mechanism; a first bracket; and a second bracket.

The cushion frame supports a seat cushion. The movable rail is attached to a portion, which is facing a floor of a vehicle, of the cushion frame with a spacer therebetween. The fixed rail supports the movable rail in a slidable manner and comprises a bottom wall facing the movable rail. The locking mechanism locks one end of the fixed rail to the floor. The first bracket is attached to the cushion frame. The second bracket is attached to the bottom wall of the fixed rail and the locking mechanism in a connecting manner.

The first bracket extends in a sliding direction of the movable rail and comprises a concave portion forming a groove that is concave toward the floor. The second bracket extends in the sliding direction and comprises a convex portion protruding toward the floor. The convex portion engages with the concave portion. The concave portion is disposed at a position to overlap at least the fixed rail if viewed in a direction orthogonal to the bottom wall of the fixed rail as well as at least the spacer if viewed in a direction parallel to the bottom wall of the fixed rail and orthogonal to the sliding axis.

According to this configuration, disposing the spacer between the movable rail and the cushion frame enables adjustment so that a distance between the cushion frame and the bottom wall of the fixed rail in a manual type sliding mechanism becomes the same as a distance between the cushion frame and the bottom wall of the fixed rail in an automatic type sliding mechanism. For this reason, a shape of the second bracket can be commonized between the manual type and the automatic type. As a result, a total cost of the vehicle seat can be reduced.

A space between the movable rail and the cushion frame can be expanded by the spacer. By disposing the first bracket in such a space, the concave portion is allowed to be close to the cushion frame in a direction parallel to the bottom wall of the fixed rail and orthogonal to the sliding direction. This allows the second bracket engaging with the first bracket, and moreover, the locking mechanism to be disposed close to the center of gravity of the cushion frame. As a result, moment that the cushion frame applies to the first bracket, the second bracket, and the locking mechanism can be reduced, thereby trimming weights thereof.

In one embodiment of the present disclosure, the first bracket and the second bracket each may be plate-like members. The concave portion may be configured of an end of the first bracket, which curves upward away from the floor. The convex portion may be configured of an end of the second bracket, which curves downward toward the floor. According to this configuration, forming and attaching the first bracket and the second bracket are easy.

One embodiment of the present disclosure may further comprise: at least one seat belt; and at least one belt fixing bracket for fixing the at least one seat belt to the cushion frame. The at least one belt fixing bracket may be fastened together with the cushion frame and the first bracket. According to this configuration, force that is applied to the belt fixing bracket by the seat belt can be dispersed to the locking mechanism and the like by the first bracket so that durability of the belt fixing bracket can be enhanced.

### BRIEF DESCRIPTION OF THE DRAWINGS

An embodiment of the present disclosure will be described below by way of example with reference to the accompanying drawings, in which:

FIG. 1 is a schematic perspective view of a vehicle seat according to the embodiment;

FIG. 2 is a schematic perspective view of a cushion frame, a sliding mechanism, and a locking mechanism of the vehicle seat of FIG. 1;

FIG. 3 is a schematic and partially enlarged perspective view of an area near the locking mechanism of the vehicle seat of FIG. 1;

FIG. 4 is a schematic sectional view taken along a line IV-VI of FIG. 3; and

FIG. 5 is a schematic sectional view of an automatic type sliding mechanism, which corresponds to FIG. 4.

### DETAILED DESCRIPTION OF THE PREFERRED EMBODIMENTS

### 1. First Embodiment

[1-1. Structure]

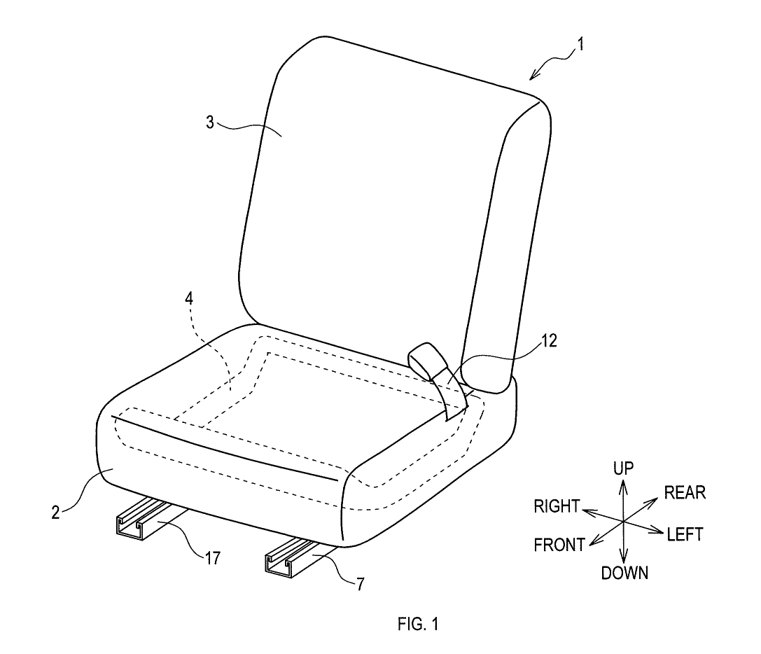

A vehicle seat 1 shown in FIG. 1 comprises: a seat cushion 2; a seat back 3; a cushion frame 4; and a seat belt 12.

The seat cushion 2 is a portion for supporting the buttocks and the like of an occupant. The seat back 3 is a portion for supporting the back of the occupant. The cushion frame 4 supports the seat cushion 2.

The seat belt 12 is a belt for fastening the body of the occupant to the seat. As shown in FIG. 1, the seat belt 12 extends upward from a space at an end of a seat-width axis of the seat cushion 2.

The vehicle seat 1 of the present embodiment is used as a rear seat of a vehicle. Directions and axes used in the following description and in the respective drawings indicate directions and axes in a state where the vehicle seat 1 is assembled to the vehicle (that is, a passenger car). Also, in the present embodiment, a seat-width direction or axis coincides with a right-left direction or axis of the vehicle, and a seat front side coincides with a vehicle front side. Further, an up-down direction or axis in the present embodiment indicates an up-down direction or axis in a use state of the vehicle seat 1, where the vehicle seat 1 is not folded.

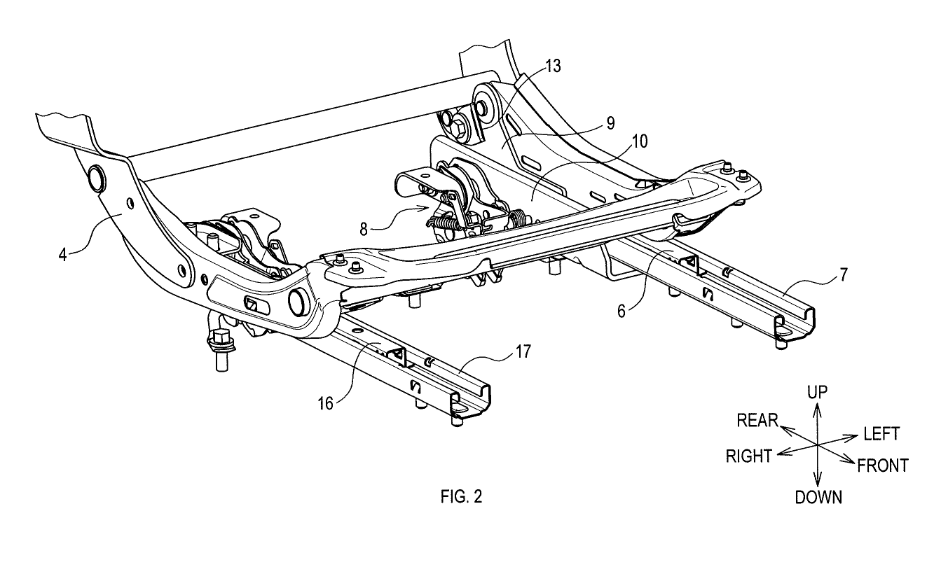

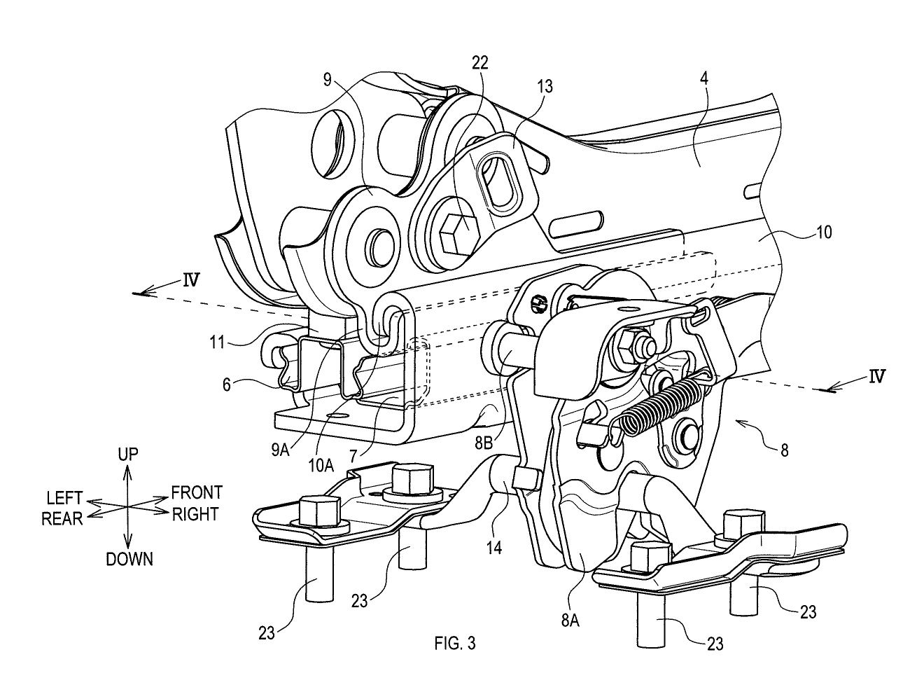

As shown in FIG. 2 and FIG. 3, the vehicle seat 1 further comprises: movable rails 6 and 16; fixed rails 7 and 17; a locking mechanism 8; a first bracket 9; a second bracket 10; a spacer 11; a belt fixing bracket 13; and a striker 14.

<Movable Rail>

The movable rails 6 and 16 are so-called upper rails and assembled with the fixed rails 7 and 17 respectively, which are to be described later, so as to configure the manual type sliding mechanism.

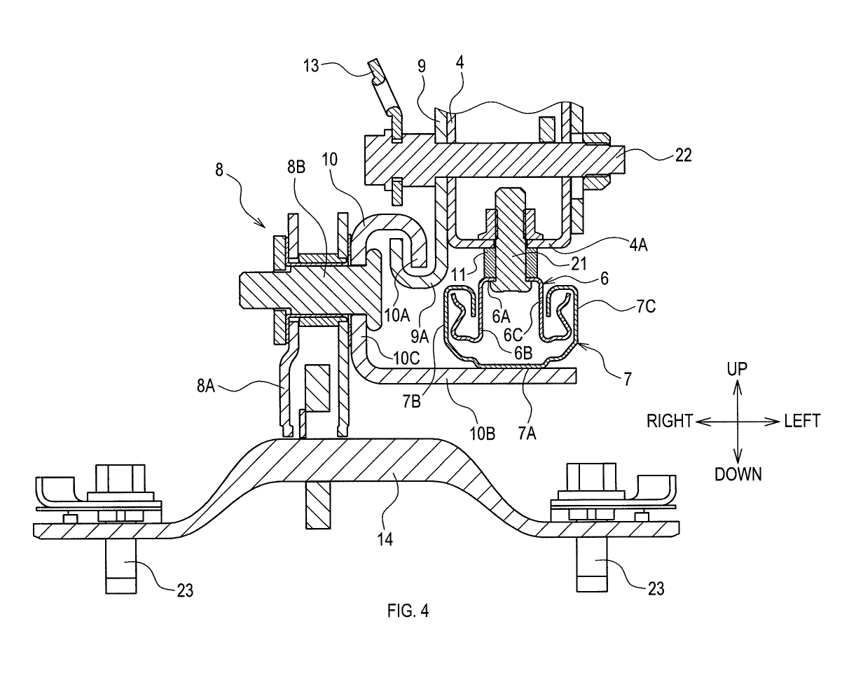

As shown in FIG. 4, each of the movable rails 6 and 16 is attached to a bottom surface of a bottom wall 4A, which is a portion facing the floor of the vehicle, of the cushion frame 4 by fastening a bolt 21 and placing the spacer 11 therebetween. Further, each of the movable rails 6 and 16 extends in a seat front-rear direction and is fixed to the cushion frame 4 at a plurality of points in the seat front-rear direction. The movable rails 6 and 16 each are configured to be slidable in the seat front-rear direction in relation to the fixed rails 7 and 17 respectively.

Each of the movable rails 6 and 16 comprises: an upper wall 6A facing the cushion frame 4; a first side wall 6B; and a second side wall 6C, which are disposed at ends of a seat-width axis of the upper wall 6A respectively and which are facing each other in the seat width direction. The two side walls 6B and 6C each extend downward from the respective ends of the seat-width axis of the upper wall 6A, each further winding outward in the seat-width direction and then, winding upward.

<Fixed Rail>

The fixed rails 7 and 17 are so-called lower rails and support the movable rails 6 and 16 respectively in a slidable manner. The fixed rails 7 and 17 are disposed apart from each other in the seat-width direction.

The fixed rails 7 and 17 extend in the seat front-rear direction. Each of the fixed rails 7 and 17 comprises: a bottom wall 7A extending in a direction orthogonal to the up-down direction (that is, parallel to the floor); a first side wall 7B; and a second side wall 7C, which are disposed at ends of a seat-width axis of the bottom wall 7A respectively and which are facing each other in the seat-width direction. The bottom wall 7A is facing each of the movable rails 6 and 16.

As shown in FIG. 4, the two side walls 7B and 7C each extend upward from the respective ends of the seat-width axis of the bottom wall 7A, each further winding toward an inside of the fixed rail 7 in the seat-width direction and then, winding downward. Specifically, respective leading-ends of the two side walls 7B and 7C each form groove-like spaces, which open at their lower sides and extend in the sliding direction.

Respective winding leading-ends of the two side walls 6B and 6C of each of the movable rails 6 and 16 are inserted to the groove-like spaces formed by the respective leading-ends of two side walls 7B and 7C of each of the fixed rails 7 and 17. In this manner, the side walls 6B and 6C of each of the movable rails 6 and 16 and the side walls 7B and 7C of each of the fixed rails 7 and 17 are disposed such that the respective leading-ends thereof surround the corresponding leading-ends, thereby limiting movement of each of the movable rails 6 and 16 in the seat-width direction.

As shown in FIG. 4, a length of a seat-width axis of the fixed rail 7 where the second bracket 10 is attached is longer than a length of a seat-width axis of the bottom wall 4A of the cushion frame 4 where the movable rail 6 corresponding to the fixed rail 7 is attached.

Ends on the seat-front side (also referred to as front ends hereinafter) of each of the fixed rails 7 and 17 are fixed to the floor of the vehicle. In contrast, ends on the seat-rear side (also referred to as rear ends hereinafter) of each of the fixed rails 7 and 17 are configured to be detachable from the floor of the vehicle by the locking mechanism 8.

<Locking Mechanism>

The locking mechanism 8 is configured to lock the rear ends of the fixed rails 7 and 17 each to the floor. The locking mechanism 8 is displaceable between a locked state where the rear ends of the fixed rails 7 and 17 each are locked to the floor and an unlocked state where the locking of the rear ends of the fixed rails 7 and 17 each to the floor is unlocked.

The locking mechanism 8 comprises a hook portion 8A and a pin 8B. The hook portion 8A is configured to be able to grip the striker 14. The hook portion 8A is disposed at a position displaced in relation to a set of the movable rail 6 and the fixed rail 7 in the seat-width direction (on the right side in the present embodiment).

The pin 8B supports the hook portion 8A in a pivotable manner around an axis parallel to the seat-width direction. The pin 8B penetrates the hook portion 8A and a leading-edge of the pin 8B is fixed to the second bracket 10. In such a manner, the hook portion 8A is pivotable relatively in relation to the second bracket 10.

When the hook portion 8A grips the striker 14 fixed to the floor, the locking mechanism 8 locks the fixed rail 7 coupled therewith via the second bracket 10, to the floor. Under such a locked state, when the cushion frame 4 is attempted to be brought up, force directing upward is applied to the second bracket 10 by the first bracket 9 and the fixed rail 7. However, since the locking mechanism 8 where the second bracket 10 is fixed is engaging with the striker 14, the second bracket 10 is not movable in the up-down direction. As a result, upward movement of the cushion frame 4 is limited.

Further, when the gripping of the striker 14 by the hook portion 8A is released, the locking of the rear ends of each of the fixed rails 7 and 17 to the floor is released. Under such an unlocked state, since movement of the second bracket 10 in the up-down direction is not limited, the cushion frame 4 is allowed to pivot upward with the front ends of the fixed rails 7 and 17, which are fixed to the floor, as anchor points. This enables a tumble (that is, folding) of the vehicle seat 1.

<First Bracket>

The first bracket 9 is a member that is attached to the cushion frame 4 and that the second bracket 10 engages with.

Specifically, the first bracket 9 is a plate-like member extending substantially in the seat front-rear direction (that is, a sliding direction of each of the movable rails 6 and 16). The first bracket 9 is fixed to a side wall of the cushion frame 4 in the seat-width direction by fastening a bolt 22.

A lower end of the first bracket 9 curves in a manner such as bending back upward away from the floor (that is, upward). Specifically, a cross-section of the first bracket 9, which is orthogonal to the sliding direction, is in a J-shape as shown in FIG. 4.

The first bracket 9 comprises a concave portion 9A configured of the above mentioned lower end. The concave portion 9A extends in the sliding direction of each of the movable rails 6 and 16, and forms a groove that is concave toward the floor.

<Second Bracket>

The second bracket 10 is attached to the bottom wall 7A of the fixed rail and the locking mechanism 8 in a connecting manner.

Specifically, the second bracket 10 is a plate-like member extending substantially in the seat front-rear direction, and comprises: a convex portion 10A; a first main body 10B; and a second main body 10C.

The first main body 10B is a portion extending in the seat front-rear direction as well as in the seat-width direction. The first main body 10B is fixed to the bottom wall 7A of the fixed rail 7 by fastening a bolt (not shown).

The second main body 10C is a portion continuing from the first main body 10B and extending in a direction orthogonal to the seat-width direction. The second main body 10C comprises a through-hole where the pin 8B of the locking mechanism 8 is inserted. The pin 8B is fixed to the second main body 10C in an unpivotal manner.

The convex portion 10A is provided so as to continue from an upper end of the second main body 10C. The convex portion 10A is configured of an end of the second bracket 10 that curves in a manner such as bending back toward the floor on a side of the movable rail 6 and the fixed rail 7. Specifically, a cross-section of the second main body 10C, which is orthogonal to the sliding direction, is in an upside-down J-shape as shown in FIG. 4.

The convex portion 10A extends in the sliding direction and protrudes toward the floor. Also, the convex portion 10A engages with the concave portion 9A by intruding from above into the groove formed by the concave portion 9A. The convex portion 10A is slidable relatively in relation to the concave portion 9A in the seat front-rear direction. Specifically, the first bracket 9 is configured to be slidable in relation to the second bracket 10 and slides together with the movable rail 6 in the seat front-rear direction.

In the present embodiment, the first bracket 9 and the second bracket 10 are provided only for the fixed rail 7 on a left side, which is also referred to as a first fixed rail 7 and disposed closer to the center of gravity of the vehicle seat 1, whereas not provided for the fixed rail 17 on the right side, which is also referred to as a second fix rail 17. However, the first bracket 9 and the second bracket 10 may be provided for both the fixed rails 7 and 17.

<Spacer>

The spacer 11 is a block-shaped member disposed between the upper wall 6A of each of the movable rails 6 and 16 and the bottom wall 4A of the cushion frame 4.

The spacer 11 is fastened by the bolt 21 together with the movable rail 6 and the cushion frame 4. The spacer 11 may be configured of a single member extending along the movable rail 6, or of separate pieces disposed at coupling positions (namely, fastening positions) each between the movable rail 6 and the cushion frame 4.

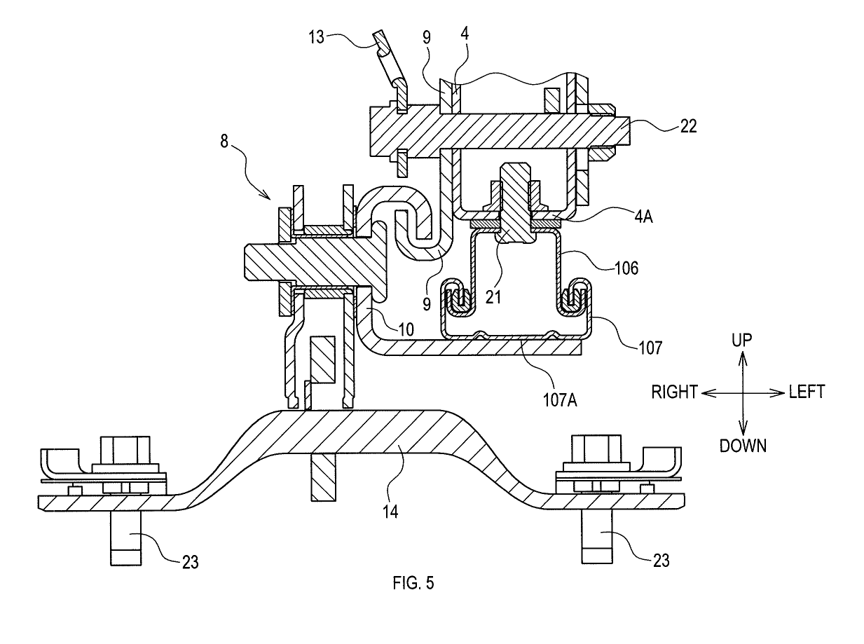

A thickness of the spacer 11 in the up-down direction is designed so that a distance between the bottom surface of the bottom wall 4A of the cushion frame 4 and an external surface of the bottom wall 7A of the fixed rail 7 becomes the same as a distance between the bottom surface of the bottom wall 4A of the cushion frame 4 and an external surface of a bottom wall 107A of a fixed rail 107 in the automatic type sliding mechanism shown in FIG. 5. More than the one spacer 11 may be disposed in a layered manner between the cushion frame 4 and the movable rail 6.

A height of a movable rail 106 of the automatic type sliding mechanism shown in FIG. 5 is larger than a height of the movable rail 6 of the manual type sliding mechanism. This is contributed to a lower position of the bottom wall 107A of the fixed rail 107, compared to a position of the bottom wall 7A of the fixed rail 7 in the manual type sliding mechanism. Simultaneously, in the automatic type sliding mechanism shown in FIG. 5, except the movable rail 106 and the fixed rail 107, the same parts as those of the manual type sliding mechanism shown in FIG. 4 are used.

<Positional Relation Between First Bracket and Other Parts>

As shown in FIG. 4, the concave portion 9A of the first bracket 9 overlaps at least the fixed rail 7 if viewed in a direction (that is, the up-down direction) orthogonal to the bottom wall 7A of the fixed rail 7 where the second bracket 10 is attached. Also, the concave portion 9A is disposed so as to overlap at least the spacer 11 if viewed in a direction (that is, the seat-width direction) parallel to the bottom wall 7A of the fixed rail 7 and orthogonal to the sliding direction.

Specifically, the spacer 11 allows the concave portion 9A of the first bracket 9 and the fixed rail 7 to be apart from each other in the up-down direction so that contact therebetween is avoided. Thus, it is not necessary for the concave portion 9A to project toward an outer side of the seat-width direction (in the present embodiment, toward the right side) in order to avoid the contact with the fixed rail 7. Therefore, a distance between the concave portion 9A and the cushion frame 4 in the seat-width direction can be reduced.

The seat belt 12 is the belt for fastening the occupant body to the seat. As shown in FIG. 1, the seat belt 12 extends upward from the space at the end of the seat-width axis of the seat cushion 2.

<Belt Fixing Bracket>

The belt fixing bracket 13 shown in FIG. 3 is a plate-like member for fixing the seat belt 12 to the cushion frame 4.

The belt fixing bracket 13 comprises at least one through-hole that allows the seat belt 12 to go through therein. Further, the belt fixing bracket 13 is fastened together with the cushion frame 4 and the first bracket 9 by the bolt 22.

<Striker>

The striker 14 is a bar-like member extending in the seat-width direction. The striker 14 at both ends thereof is fastened to the floor of the vehicle by a plurality of bolts 23.

The hook portion 8A of the locking mechanism 8 in the locked state engages with a portion that is farther apart from the sliding mechanism than the center of gravity of the striker 14 in the seat-width direction (that is, on the right side of the center of gravity).

[1-2. Effects]

In the embodiment as has been described in details so far, the following effects can be obtained.

(1a) Disposing the spacer 11 between each of the movable rails 6 and 16 and the cushion frame 4 enables adjustment so that a distance between the cushion frame 4 and the bottom wall 7A of the fixed rail 7 in the manual type sliding mechanism becomes the same as a distance between the cushion frame 4 and the bottom wall 107A of the fixed rail 107 in the automatic type sliding mechanism. For this reason, a shape of the second bracket 10 can be commonized between the manual type and the automatic type. As a result, a total cost of the vehicle seat 1 can be reduced.

(1b) A space between the movable rail 6 and the cushion frame 4 can be expanded by the spacer 11. By disposing the first bracket 9 in such a space, the concave portion 9A is allowed to be close to the cushion frame 4 in the seat-width direction. This allows the second bracket 10 engaging with the first bracket 9, and moreover, the locking mechanism 8 to be disposed close to the center of gravity of the cushion frame 4. As a result, moment that the cushion frame 4 applies to the first bracket 9, the second bracket 10, and the locking mechanism 8 can be reduced, thereby trimming weights thereof.

(1c) Since the first bracket 9 and the second bracket 10 each are configured of the plate-like members whose respective leading edges are curved, forming and attaching the first bracket 9 and the second bracket 10 are easy.

(1d) Since the belt fixing bracket 13 is fastened together with the first bracket 9, force that is applied to the belt fixing bracket 13 by the seat belt 12 can be dispersed to the locking mechanism 8 and the like by the first bracket 9. As a result, durability of the belt fixing bracket 13 can be enhanced.

### 2. Other Embodiments

The embodiment of the present disclosure has been described above. However, the present disclosure is not limited by the aforementioned embodiment, and can be practiced in various manners.

(2a) The shapes of the first bracket 9 and the second bracket 10 in the vehicle seat 1 of the aforementioned embodiment are merely examples. As long as the first bracket 9 and the second bracket 10 each comprise the concave portion 9A and the convex portion 10A respectively, the first bracket 9 and the second bracket 10 are not limited to the plate-like members.

(2b) In the vehicle seat 1 of the aforementioned embodiment, the belt fixing bracket 13 is not necessarily fastened together with the cushion frame 4 and the first bracket 9. Specifically, the belt fixing bracket 13 and the first bracket 9 can be fixed to the cushion frame 4 individually and separately.

(2c) The vehicle seat 1 of the aforementioned embodiment can be applied as a seat of an automobile other than a passenger car as well as a seat of a vehicle other than an automobile, such as a train car, a ship, and an aircraft.

(2d) Functions of one constituent element in the aforementioned embodiment may be divided and separately performed by a plurality of constituent elements, or functions of a plurality of constituent elements may be integrated and performed by one constituent element. Part of the configuration in the aforementioned embodiment may be omitted. Addition, replacement, and the like of at least part of the configuration in the aforementioned embodiment may be carried out with respect to the configuration in the aforementioned other embodiment. Any modes included in the technical ideas specified by the languages of the claims are embodiments of the present disclosure.

What is claimed is:

1. A vehicle seat comprising:
a cushion frame that supports a seat cushion;
a movable rail that is attached to a portion, which is facing a floor of a vehicle, of a cushion frame with a spacer therebetween:
a fixed rail that supports the movable rail in a slidable manner and that comprises a bottom wall facing the movable rail;
a locking mechanism that locks one end of the fixed rail to the floor;
a first bracket that is attached to the cushion frame; and
a second bracket that is attached to the bottom wall of the fixed rail and the locking mechanism in a connecting manner,
wherein the first bracket extends in a sliding direction of the movable rail and comprises a concave portion forming a groove that is concave toward the floor,
wherein the second bracket extends in the sliding direction and comprises a convex portion protruding toward the floor,
wherein the convex portion engages with the concave portion, and
wherein the concave portion is disposed at a position to overlap at least the fixed rail if viewed in a direction orthogonal to the bottom wall of the fixed rail as well as at least the spacer if viewed in a direction parallel to the bottom wall of the fixed rail and orthogonal to the sliding axis.

2. The vehicle seat according to claim 1,
wherein the first bracket and the second bracket each are plate-like members,
wherein the concave portion is configured of an end of the first bracket, which curves upward away from the floor, and
wherein the convex portion is configured of an end of the second bracket, which curves downward toward the floor.

3. The vehicle seat according to claim 1, further comprising:
at least one seat belt; and
at least one belt fixing bracket for fixing the at least one seat belt to the cushion frame,
wherein the at least one belt fixing bracket is fastened together with the cushion frame and the first bracket.
